(19) United States
(12) Patent Application Publication
(10) Pub. No.: US 2004/0081867 A1
(43) Pub. Date: Apr. 29, 2004

(54) Distributed fuel cell network

(76) Inventor: David J. Edlund, Bend, OR (US)

Correspondence Address: Kolisch Hartwell, P.C., 520 S.W. Yamhill Street, Suite 200, Portland, OR, 97204, US

(21) Appl. No.: 10/280,015

(22) Filed: Oct. 23, 2002

(51) Int. Cl. H01M 8/04; H01M 8/06

(52) U.S. Cl. 429/22; 429/34; 429/19

(57) ABSTRACT

A distributed fuel cell network and communication systems and subassemblies for use therein. The network includes at least one, and typically a plurality of, fuel cell systems. Each fuel cell system includes a fuel cell stack that is adapted to produce an electric current from oxygen and a source of protons, such as hydrogen gas. The fuel cell systems further include communication subsystems that enable remote monitoring and/or control of the fuel cell systems from a remotely located servicing system, which includes a corresponding communication subsystem. The remotely located servicing system is adapted to monitor and/or control the operation of the fuel cell systems and in some embodiments may include a redundancy of remote servicing units. In some embodiments, the fuel cell systems also include local controllers, while in other embodiments the fuel cell systems do not include local controllers.

### FIELD OF THE INVENTION

The present invention is directed generally to fuel cell systems, and more particularly to a distributed fuel cell network.

### BACKGROUND OF THE INVENTION

An electrochemical fuel cell is a device that converts fuel and oxidant to electricity, reaction product, and heat. Fuel cells commonly are configured to convert oxygen and a proton source, such as hydrogen, into water and electricity. In such fuel cells, the hydrogen is the fuel, the oxygen is the oxidant, and the water is the reaction product.

The amount of electricity produced by a single fuel cell may be supplemented by connecting one or more additional fuel cells to the existing fuel cell. A plurality of fuel cells connected together are referred to as a fuel cell stack, with the fuel cells typically connected together in series. Fuel cell stacks may be incorporated into a fuel cell system, which includes a source of hydrogen gas or other fuel for the fuel cell stack, and which typically also includes other components adapted to facilitate the conversion of fuel and oxidant into electricity. Conventionally, some fuel cell systems include integrated controllers that regulate the operation of the fuel cell system. These onboard, or integrated, local controllers are typically housed within a common shell with the fuel cell stack and other components of the fuel cell system. While this configuration may be effective when a trained technician is routinely available to inspect the operation of the system, commercial application of fuel cell systems means that the systems will be owned and/or operated by ordinary consumers and other individuals that are not specially trained in the operation and/or maintenance of fuel cell systems. Similarly, and regardless of the level of training of the user, the use of an onboard local controller requires a separate controller for each fuel cell stack and does not provide for backup or auxiliary control and/or monitoring of the system, such as when a technician is not present at the system and/or should the local controller malfunction or otherwise not be configured to respond to a particular operating state of the fuel cell system.

### SUMMARY OF THE INVENTION

The present invention is directed to a distributed fuel cell network and communication systems and subassemblies for use therein. The network includes at least one, and typically a plurality of, fuel cell systems. Each fuel cell system includes a fuel cell stack that is adapted to produce an electric current from an oxidant and a source of fuel, such as hydrogen gas. The fuel cell systems further include communication subsystems that enable remote monitoring and/or control of the fuel cell systems from a remotely located servicing system, which includes a corresponding communication subsystem. The remotely located servicing system is adapted to monitor and/or control the operation of the fuel cell systems and in some embodiments may include a redundancy of remote servicing units. In some embodiments, the fuel cell systems also include local controllers, while in other embodiments, the fuel cell systems do not include local controllers.

### BRIEF DESCRIPTION OF THE DRAWINGS

FIG. 1 is a schematic view of a distributed fuel cell network according to the present invention.

FIG. 2 is a schematic view of a fuel cell system configured to use in distributed fuel cell networks according to the present invention.

FIG. 3 is a schematic view of an illustrative fuel cell system communication subsystem configured for use in the fuel cell system of FIG. 2.

FIG. 4 is a schematic view of a remote servicing system configured for use in distributed fuel cell networks according to the present invention.

FIG. 5 is a schematic view of an illustrative processing subsystem for a remote servicing system for use in distributed fuel cell networks according to the present invention.

FIG. 6 is a schematic view of another illustrative processing subsystem for a remote servicing system for use in distributed fuel cell networks according to the present invention.

FIG. 7 is a schematic view of another illustrative processing subsystem for a remote servicing system for use in distributed fuel cell networks according to the present invention.

FIG. 8 is a schematic view of a redundantly controlled fuel cell network according to the present invention.

FIG. 9 is a schematic view of another redundantly controlled fuel cell network according to the present invention.

FIG. 10 is a schematic view of another redundantly controlled fuel cell network according to the present invention.

FIG. 11 is a schematic view of an illustrative fuel cell.

FIG. 12 is a schematic view of an illustrative fuel cell system for use in fuel cell networks according to the present invention.

FIG. 13 is a schematic view of another illustrative fuel cell system for use in fuel cell networks according to the present invention.

FIG. 14 is a schematic view of an illustrative example of a suitable fuel processor for use in fuel cell networks according to the present invention.

FIG. 15 is a schematic view of another suitable fuel processor for use in fuel cell networks according to the present invention.

### DETAILED DESCRIPTION AND BEST MODE OF THE INVENTION

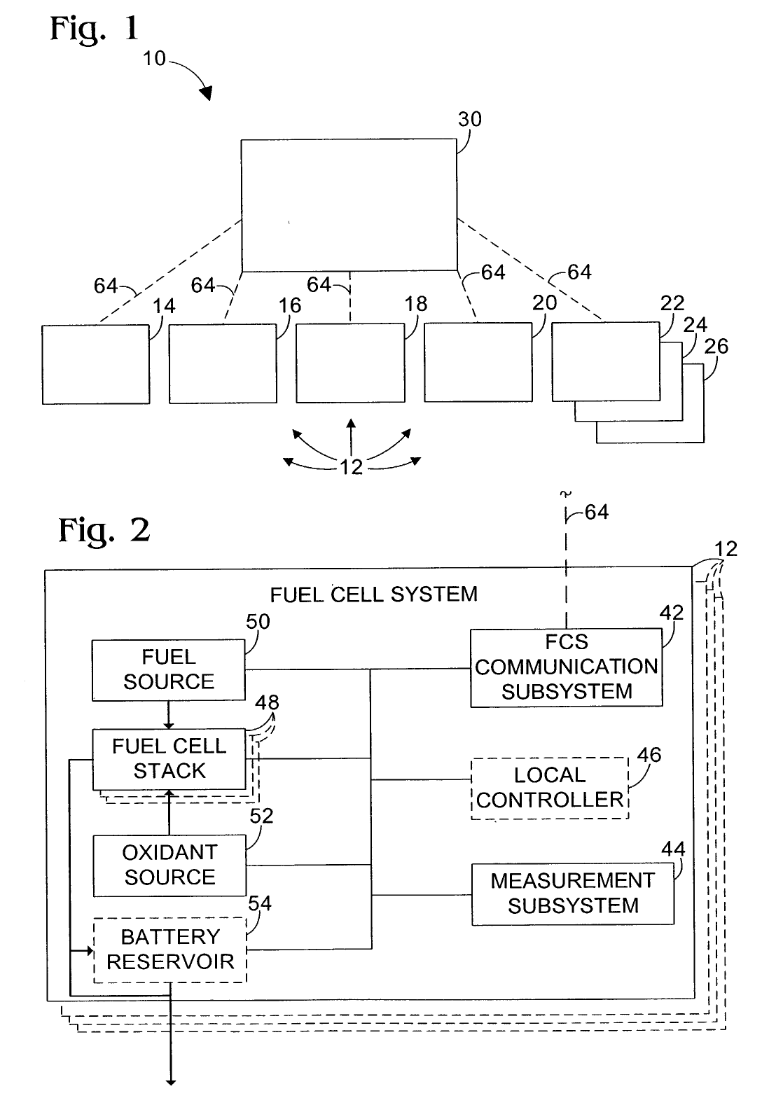

A distributed fuel cell network is shown in FIG. 1 and indicated generally at 10. Fuel cell network 10 includes a plurality of fuel cell systems (FCS) 12, such as fuel cell systems 14-26. The fuel cell network also includes a remote servicing system (RSS) 30, which is configured to communicate with each of the fuel cell systems. Accordingly, the fuel cell systems may be referred to as networked fuel cell systems in that they are configured to be serviced by a common remote servicing system. Although FIG. 1 shows seven fuel cell systems, the number of fuel cell systems in network 10 may vary from only a few systems, such as 2-5, 6-10, etc., to dozens or hundreds of fuel cell systems or more. The exemplary FCS's shown in FIG. 1 also schematically demonstrate that it is within the scope of the invention that the individual fuel cell systems may individually communicate with the remote servicing system, such as demonstrated by FCS's 14-20, and/or that groups of two or more FCS's may collectively communicate with the RSS, such as demonstrated by FCS's 22-26.

As schematically illustrated in FIG. 1, the fuel cell systems are remotely located relative the remote servicing system. As used herein the term “remotely” means physically separated and located apart from one another. It is within the scope of the present invention to separate a fuel cell system and a remote servicing system by any suitable distance within the communication limits of the subsequently described communication subsystems. Accordingly, a fuel cell system within network 10 may be separated from remote servicing system 30 by distances up to several thousand miles, such as from one continent to another. However, it is also possible to implement the invention on a smaller scale, such as within a communication radius of 500 miles, 250 miles, 100 miles, 50 miles, 25 miles, 10 miles, 1 mile, etc. For example, a remote servicing system located in a building may service a plurality of fuel cell systems located throughout the state or geographic region in which the building is located, the city in which the building is located, the building, the building and/or in adjacent buildings, and/or within a predetermined range of the remote servicing system.

Therefore, unlike a conventional fuel cell system, which includes at most a dedicated local controller that is responsible only for that particular fuel cell system, and which is integrated into the housing of the fuel cell system and/or otherwise directly coupled thereto; the present invention is directed to a distributed fuel cell network in which a remote servicing system 30 communicates with a plurality of remotely located fuel cell systems 12. The remotely located fuel cell systems may in turn be remotely located relative to one another, and/or may be located at the same site. For example, a neighborhood of residences and/or businesses may be serviced by the same remote servicing system, where each residence and/or business has one or more fuel cell systems configured to act as a primary power source and/or backup an electric utility. In another example, one or more fuel cell systems may serve as a power source (primary and/or backup) for a moving vehicle such as a ship, car, truck, airplane, etc., and each such fuel cell system may communicate with the same remote servicing system. Fuel cell systems configured to provide energy for different classes of devices may communicate with the same remote servicing system. For example, a remote servicing system may communicate with any single class or combination of classes including: vehicles, residences, commercial buildings, tools, appliances, stationary devices, etc. It is within the scope of the invention to configure a fuel cell network for virtually any other suitable application, and the above are provided as illustrative examples.

A single remote servicing system configured to communicate with a plurality of fuel cell systems may remotely monitor and/or control such systems. As used herein, the term “service” or “servicing” will be used to refer to an RSS remotely monitoring and/or controlling one or more fuel cell systems. As discussed in more detail herein, this servicing may include (1) pure monitoring, in which the RSS only receives data from the FCS(s), such as one or more operating parameters and/or states of the FCS, (2) pure control, in which the RSS sends to the FCS command signals that are not based upon monitored or measured operating conditions or states of the FCS, or preferably, (3) a combination of both monitoring and control, in which the command signals sent to the FCS may be executed at least partially or completely in response to data received from the FCS.

Configuring a remote servicing system to service a plurality of fuel cell systems may increase the efficiency, safety, longevity, and/or cost effectiveness of the overall fuel cell network. There is no theoretical limit to the number of fuel cell systems that each remote servicing system may service. For a given fuel cell network, a particular ratio of remote servicing systems to fuel cell systems may be selected. For example, if it is more cost effective to service a particular set of fuel cell systems with a new remote servicing system, such a remote servicing system may be added to the fuel cell network. On the other hand, if servicing the set of fuel cell systems with an existing remote servicing system would be more cost effective, the existing remote servicing system may be adapted to service the set. Furthermore, the number of remote servicing systems included in a given network may be selected to provide the desired level of cost effectiveness, network efficiency, and/or redundancy. For example, increasing the number of remote servicing systems may increase the overall cost of the network, but may improve network performance and decrease the chance of network failure, such as if the individual remote servicing systems are configured to back each other up.

FIG. 2 schematically depicts an illustrative fuel cell system 12 that may be used in a fuel cell network 10 according to the present invention. The fuel cell system includes a FCS communication subsystem 42, measurement subsystem 44, local controller 46, fuel cell stack 48, fuel source 50, oxidant source 52, and battery reservoir 54. Battery reservoir 54 contains one or more batteries that are adapted to store electrical current produced by the fuel cell stack, and as such may also be referred to as a battery bank. This stored charge, or current, may be used to supplement the current produced by the fuel cell stack, and/or to provide current when the fuel cell stack is not producing current, such as during startup of the fuel cell system or when the fuel cell stack is otherwise offline. Fuel cell systems may be configured differently in order to optimally serve a particular need, and fuel cell systems of the present invention may not include all of the above listed constituent components and/or may include alternative and/or additional constituent components, such as energy consuming device(s), additional fuel cell stacks, heating/cooling units, additional fuel and/or oxidant sources, etc. In this respect, examples of fuel cell systems without the communication subsystem and associated componentry of the present invention are disclosed in U.S. Pat. Nos. 6,403,249, 6,242,120, 6,083,637, 5,879,826, 5,637,414, 5,432,710, 5,401,589 and 4,098,959, and U.S. patent application Ser. Nos. 09/477,128 and 10/153,282, the complete disclosures of which are hereby incorporated by reference for all purposes.

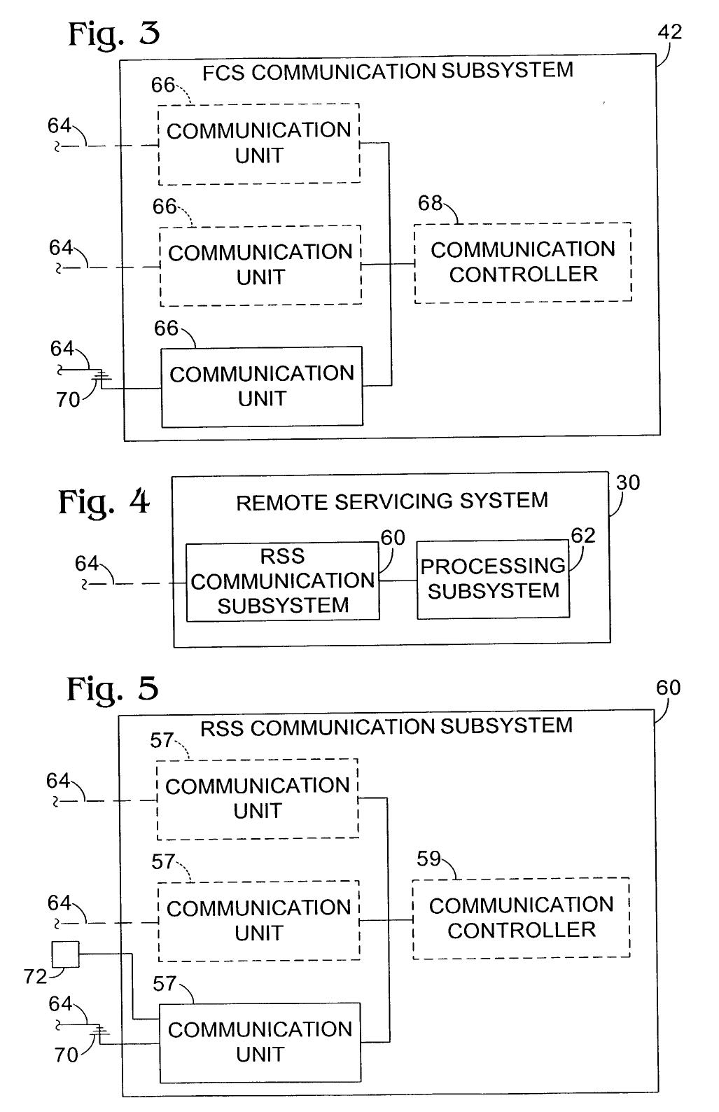

As introduced above, fuel cell system 12 includes a FCS communication subsystem 42. Subsystem 42 is configured to facilitate remote communication with remote servicing system 30. FCS communication subsystem 42 is typically complementarily configured to an RSS communication subsystem of remote servicing system 30, such as shown in FIG. 4 at 60, so that the remote servicing system and the fuel cell system may communicate remotely, as described in more detail herein.

FCS communication subsystem 42 is configured to communicate with RSS communication subsystem 60 via one- or two-way communication signals 64, which are schematically illustrated in FIGS. 1 and 2. The FCS and RSS communication subsystems may collectively be referred to as a network communication subsystem. The communication subsystems may utilize any suitable mechanism(s) and/or protocol(s) to transmit and/or receive signals 64. For example, the FCS communication subsystem may be adapted to transmit signals 64 to and/or from RSS communication subsystem 60 via a wired network such as a telephone network, a wired electric signal network, a fiber optics network, etc. FCS communication subsystem 42 may additionally or alternatively be adapted to transmit signals 64 to and/or from the RSS communication subsystem via a wireless network, such as a satellite network, a cellular network, a radio network, etc. The fuel cell system and remote servicing system may be adapted to utilize existing networks, such as the Internet, or to communicate via a dedicated network, which may be established primarily to facilitate communication within the fuel cell network; and either public, private, or a combination of public and private networks may be used. The FCS communication subsystem may communicate with a particular remote servicing system using a particular mechanism and protocol, while communicating with another remote servicing system using a different mechanism and/or protocol.

Analog or digital communication signals 64 may be used for transmitting control signs, data, measured values, or other information between the fuel cell systems and the corresponding remote servicing system(s). When an analog signal is used, the signal may be transmitted at any appropriate frequency, as may be determined by a particular application and/or any pertinent regulations and/or to comply with any pertinent standards. Digital signals may be compressed or uncompressed, and it is within the scope of the invention to encrypt or otherwise encode transmitted signals. A communication signal may also use a combination of analog and digital signals. For example, an analog electrical signal may travel via radio waves to an analog-to-digital (AD) converter where the signal is converted into a digital signal that may be transmitted via a digital satellite signal. It is also within the scope of the invention that the FCS's associated with a particular RSS may, relative to each other, individually utilize the same or different signal types, protocols and/or mechanisms.

As schematically illustrated in FIG. 3, FCS communication subsystem 42 may include one or more communication units, such as indicated at 66. For example, the FCS communication subsystem may be adapted to communicate with RSS 30 via plural mechanisms, such as satellite, telephone, radio, etc. In such an embodiment, the FCS communication subsystem may include a communication unit configured to facilitate one or more of each supported type of communication. For example, one communication unit may be configured to handle radio communications, another to handle cellular communications, and yet another that is configured to handle both satellite and fiber optics communications. Other combinations are possible and are within the scope of the present invention, with the preceding being provided as an illustrative example. A communication controller 68 may be present to parse the different types of communication for processing. The communication subsystem may physically reside in the same housing, or may alternatively include plural discrete components operatively connected to one another. The communication subsystem typically includes one or more suitable antennas 70 when configured for satellite, cellular, radio, or other wireless communication.

FCS communication subsystem 42 may be configured to transmit and/or receive communication signals 64 containing virtually any type of information and/or instructions. Some transmissions may be very brief, such as a ping, or other suitable query or signal, to determine if an RSS is still online. Other transmissions may be larger and/or more complex, such as a transmission of stored operating data from an FCS, downloading of software updated from the RSS, etc. In other words, the communication signals may vary in size and complexity, depending for example upon such factors as the type of information being transmitted, the type of servicing being effected, and the nature of the communication signal (data, command signals, operating system/software updates, etc.).

As an example, the FCS communication subsystem may transmit to RSS 30 communication signals 64 containing data corresponding to one or more operating parameters that may be used to model or otherwise define the operating state, or a portion thereof, of the fuel cell system. As used herein, “operating state” is used to describe the overall operation (or lack thereof) of the fuel cell system, or a portion thereof, and the many aspects of such operation that may be characterized by discrete operating parameters. Each of these operating parameters may be derived from one or more measured value, set condition, analyzed data, etc. For example, an operating parameter may describe the energy-producing (operating) state of the fuel cell system (on, off, standby, warm-up, cool-down, etc.). Other operating parameters may be used to describe the temperature, pressure, purity, efficiency, battery reserve, etc. of various portions of the fuel cell system. Some operating parameters may directly reflect a measured value; for instance, a temperature parameter may model the measured temperature of a portion of the fuel cell stack. Other operating parameters may be derived from one or more measured values. For example, a measured pressure and a measured flow rate may be used to calculate a contamination parameter, or a battery reserve measurement and an average load measurement may be used to calculate a remaining duration of operation parameter. In general, different types of operating parameters may be measured, calculated, set, etc. Plural operating parameters may collectively be used to either completely or partially model an operating state of the fuel cell system, and such parameters may be transmitted via the FCS communication subsystem. As used herein, the operating parameters of a fuel cell system may include one or more operating parameters relating to the operating environment in which the fuel cell system is used, such as the temperature of the environment and/or the load being applied to the fuel cell system.

When the RSS is adapted to receive communication signals containing measured data from a fuel cell system 12 within its network, the fuel cell system will typically include a measurement subsystem 44 that is configured to measure or otherwise determine operating parameters that may be transmitted via the FCS communication subsystem. The measurement subsystem is typically configured to take various measurements such as temperatures, pressures, electric currents, concentrations, flow rates, fuel and oxidant levels, etc. Accordingly, the measurement subsystem may include one or more suitable measurement devices, or sensor assemblies, adapted to measure, or otherwise acquire, operating parameters of the fuel cell system. For example, to measure temperatures, the measurement subsystem may include one or more thermistor, thermometer, thermocouple, or other temperature-measuring devices. Similarly, a Bourdon gauge, manometer, pressure transducer or other pressure gauge may be used to measure pressures, and voltmeters, ammeters, and ohmmeters may be used to respectively measure potential differences, electric current magnitudes, and electrical resistances. Other measurement devices may be used for appropriate measurements. The measurement subsystem may continually measure predetermined operating parameters and/or may sample measurements according to a configurable schedule. Measurements may also be taken in response to predefined events and/or in response to user commands, which may be remotely transmitted to the fuel cell system. As described herein, such measurements may be compiled and/or transmitted for compilation.

The FCS communication subsystem may receive communication signals 64 containing transmitted information and instructions, such as from RSS 30 via RSS communication subsystem 60. Such transmissions may be used to alter the operating state and/or operating parameter(s) of the fuel cell system, inquire about usage statistics, and/or even update software or firmware of the fuel cell system. For example, the operating state of the fuel cell system may be adjusted by commands such as a command instructing the system to change from an “off” condition to an “on” condition, by a command that adjusts (stops, starts, increases, decreases, etc.) the circulation of a cooling fluid throughout the fuel cell stack or other component of the fuel cell system to control the temperature thereof, or by a command that adjusts hydrogen production and/or delivery rate to optimize energy conversion. It should be understood that the above examples are merely illustrative examples of the many ways in which the operating state and/or operating parameters of a FCS may be adjusted.

As shown in FIG. 2, fuel cell systems according to the present invention may, but are not required to, include a local controller 46. Local controller 46 may operate independent of RSS 30, responsive to command signals from the RSS, or both. By this latter configuration, it is meant that the local controller may be configured to control the operation of the fuel cell system, with the RSS being configured to service the same fuel cell system, such as by monitoring the FCS's operation, sending control signals thereto (such as to start up, shut down, or otherwise adjust the operating state or parameters of the fuel cell system, etc.). For example, in a network in which the RSS performs only monitoring of the fuel cell system, the local controller may control the operating parameters, and thereby the operating state of the fuel cell stack, such as responsive to stored command sequences, responsive to measured operating parameters, etc. An illustrative, non-exclusive, example of a suitable local controller is disclosed in U.S. Pat. No. 6,383,670, the complete disclosure of which is hereby incorporated by reference.

As discussed, RSS 30 will often be configured to at least partially, or even completely, control the operation of the fuel cell stack by sending command signals thereto. It is within the scope of the invention that any monitoring or control that may be accomplished by a local controller may be additionally or alternatively accomplished using RSS 30. As also discussed, these command signals may be selected or sent independent of operating parameters measured by measurement subsystem 44, and/or selected or sent responsive at least in part to the measured operating parameters. When the RSS is configured to send command signals to fuel cell system 12, the command signals may be sent to local controller 46, which in turn relays local command signals to the components of the fuel cell system to be controlled. Such a configuration may be particularly useful when the local controller is also adapted to control the operation of the fuel cell system without requiring a command signal from RSS 30 to initiate the control function. In such an embodiment, the local controller will be operatively in communication with the components of the fuel cell system to selectively control the operation thereof. As such, these local communication linkages may be utilized to implement control signals from RSS 30 and/or command signals from local controller 46. It is also within the scope of the invention that fuel cell system 12 may be implemented without a local controller 46, in which case the RSS will send control signals to the fuel cell system, with these command signals being transmitted, routed, or otherwise communicated to the components to be controlled by the FCS communication subsystem or other suitable device. Furthermore, it is within the scope of the invention to directly route such communications to the various components without relaying through a local controller, even if the FCS includes a local controller.

An illustrative example of a suitable RSS 30 is schematically shown in FIG. 4. As shown, system 30 includes the previously introduced RSS communication subsystem 60 that is adapted to communicate with the corresponding FCS communication subsystems of one or more fuel cell systems 12. Like FCS communication subsystem 42, the RSS communication subsystem may be configured to communicate via any suitable type and number of mechanisms and/or protocols. As shown in FIG. 5, the RSS communication subsystem may include one or more communication units 57, such as for communication via a variety of protocols or mechanisms. The communication subsystem may also include a communication controller 59.

FIG. 4 also demonstrates that the RSS includes a processing subsystem 62 that communicates with the RSS communication subsystem. The processing subsystem may be configured to receive communication signals 64 that include operating parameters and/or other information that are received from networked fuel cell systems and relayed by the network communication subsystem. Additionally or alternatively, the processing subsystem may transmit communication signals 64 that include instructions, such as command signals and/or other information, to networked fuel cell systems via the network communication subsystem. The instructions enable the remote servicing system to control the operation of the fuel cell systems, such as by changing the operating state and/or operating parameters of the fuel cell systems. The instructions may include prompts for the measurement subsystem to measure and/or transmit to the processing system one or more operating parameters. It should be understood that the processing subsystem may be differently implemented depending upon the particular type(s) of servicing provided to networked fuel cell systems.

Because the remote servicing system may communicate with and send common instructions to a plurality of remotely located fuel cell systems, the remote servicing system may simultaneously control plural fuel cell systems as a group from the same remote location. However, the RSS preferably may also individually control any of the networked fuel cell systems. For example, in some situations it may be desirable to start up, shut down, ramp up, ramp down, etc. plural fuel cell systems as a group at the same time. In other situations, such as where one of a plurality of fuel cell systems is malfunctioning, is functioning at a higher or lower than desired capacity, is operating at a different operating state than the other fuel cell systems, etc., it may be desirable for the RSS to control the operation of that fuel cell system without altering the operating state or parameters of the other networked fuel cell systems with which the RSS is in communication.

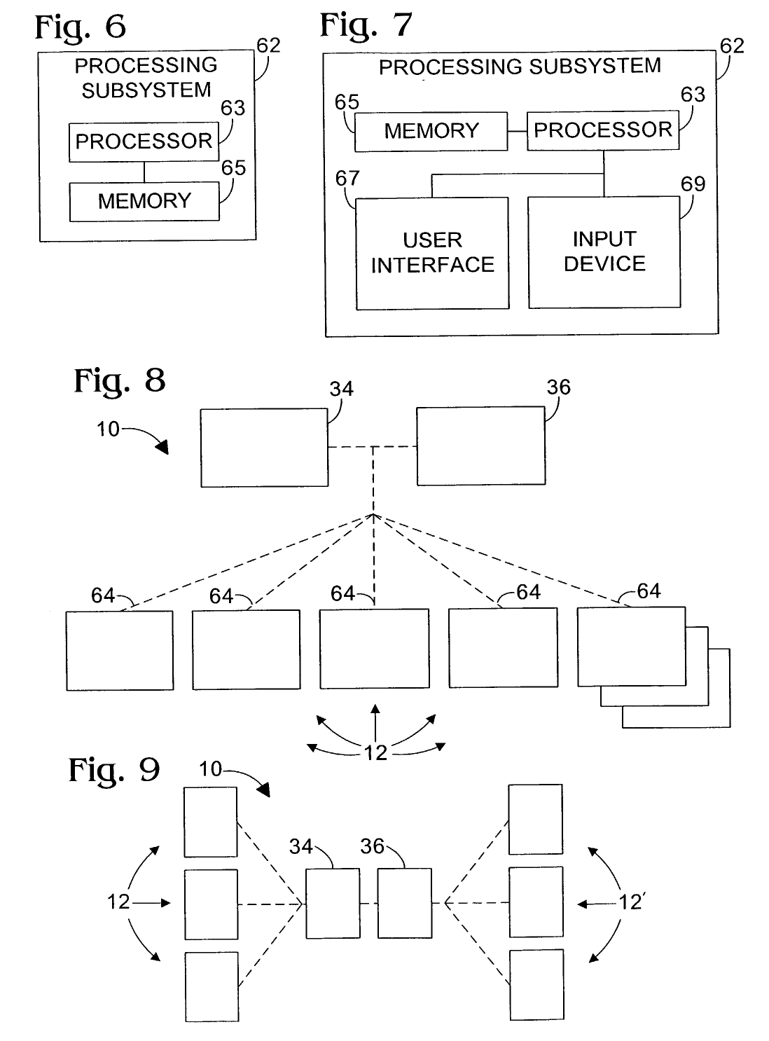

Processing subsystem 62 may be configured for automated operation, manual operation, or both automated and manual operation. As shown in FIG. 6, the processing system may include a processor 63 for executing instructions, and a memory 65 for storing executable instructions, data, such as data representing transmitted operating parameters, and/or other information. When configured for automated operation, the remote processing subsystem does not require a human operator to service the one or more remote fuel cell systems. Instead, the remote processing subsystem is programmed or otherwise configured to automatically monitor and/or control a plurality of fuel cell systems. The subsystem may automatically monitor operation of the fuel cell systems, for example by receiving and storing parameters transmitted from the fuel cell systems. The remote processing subsystem may also be configured to send a particular command signal in response to the occurrence or nonoccurrence of a predetermined triggering event or at a predetermined time. Monitored parameters may be automatically analyzed and used to evaluate the operating condition of a fuel cell system, and automated control of the fuel cell system may be based on such evaluations. As one example, a set of received parameters may be analyzed (either discretely or over time with reference to previously measured operating parameters) to detect trends that may indicate potential system failure and/or a future operating state of the fuel cell system. In such a situation, the remote processing subsystem may be programmed to rectify the detected condition or to prevent the potential future operating state and/or system failure from becoming a reality by transmitting to the fuel cell system operating instructions that are configured to adjust the operating state of the fuel cell system at least partially responsive to the analysis. These adjustments may include one or more of adjusting at least one operating parameter of the fuel cell system, ramping the system (or component thereof) up or down, shutting off the fuel cell system (or component thereof), regulating the load applied to the fuel cell system, isolating the fuel cell stack, transitioning the fuel cell system (or component thereof) to a different operating state, etc. The remote processing subsystem may alternatively or additionally be configured to provide notification of the detected condition. The subsystem may provide notification to another system or subsystem, or to a human operator. Illustrative, non-exclusive examples of these trends include changes over time in the pressure or temperature in a portion of the fuel cell system, temperature or pressure change between selected portions of the fuel cell system, composition of a stream within or produced by the system, etc.

The processing subsystem may alternatively or additionally be configured for manual operation. When configured for manual operation, an operator may remotely monitor and/or control networked fuel cell systems via the processing subsystem. For example, as shown in FIG. 7, the processing subsystem may present information, such as the measured operating parameters and/or analyzed data derived therefrom, to the operator via a user interface 67. Furthermore, the operator may utilize an input device 69 to direct the remote servicing system to transmit control signals to a fuel cell system. In this way, the fuel cell system may be remotely controlled by an operator. Exemplary user interfaces include displays presenting graphical user interfaces, text-based user interfaces, etc, as well as other suitable presentation mechanisms. The input device may include a keyboard, pointing device, voice recognition device, etc. In some embodiments, the remote servicing system includes a programmable computer with an associated display, which may be adapted to present the user interface, and a keyboard for accepting input. Manual control permits an operator to remotely service plural fuel cell systems even though the systems may be physically located apart from one another, and even great distances apart from one another. Therefore, a single operator may service a greater number of fuel cell systems.

As discussed above, the remote processing subsystem may be configured for combined manual and automated operation. For example, the subsystem may be configured to automatically monitor and control networked fuel cell systems, but allow manual overrides, if for example, an operator desires to take control. Similarly, the subsystem may automatically monitor and control the fuel cell systems under conditions predetermined to represent normal operating conditions, yet yield control to an operator during abnormal conditions. Combining manual operation with automated operation allows a single operator to monitor an even greater number of fuel cell systems. The operator need only focus on a particular fuel cell system if the system notifies the operator that that fuel cell system warrants attention or if the operator decides to study that system. Because under normal circumstances the fuel cell systems do not require individual manual attention, in such an embodiment a single operator may manage a large fuel cell network, such as a fuel cell network including 10, 25, 50, 100, 1,000, or more fuel cell systems.

The RSS communication subsystem also may be configured to communicate with devices other than fuel cell systems of the fuel cell network. For example, the RSS communication unit may be configured to relay operating parameters and/or other information to other devices on a network via relay signals. FIG. 5 schematically illustrates a mobile computing device 72 communicating with the remote servicing system. The mobile computing device, or any other suitable device configured to communicate with the remote servicing system, may receive operating parameters and/or transmit command signals. In this manner, the fuel cell systems may be manually serviced by an operator located away from the remote servicing system. Thus, if an abnormal condition arises, the remote servicing system may send a notification to an operator. Such a notification may be sent to the operator's telephone, e-mail, pager, etc. Therefore, an operator may promptly address the condition, and thus reduce the likelihood of damage being caused to the fuel cell system. The remote servicing system may communicate with a variety of different devices via a plurality of network types. For example, telephones, computers, and personal data assistants may communicate with the remote servicing system via the Internet, cellular phone networks, radio networks, or other suitable networks.

The communication subsystems of the RSS and FCS's may also be used to transmit usage statistics. The usage statistics may be transmitted either as compiled data, or real time information that may be subsequently compiled, such as by the monitoring subsystem of RSS 30 or by an associated device that receives and compiles data. Compiled data may include duration of operation, average load, maximum load, total power delivered, fuel levels, battery levels, temperatures, pressures, etc. Such data may be collected and compiled by the local controller of the fuel cell system and then transmitted to the RSS. It is also within the scope of the invention to collect real-time information such as the current load, temperature, pressure, etc. that may be transmitted to RSS 30 as it is measured by measurement subsystem 44 and thereafter used to compile statistics such as those described above. In either case, it is within the scope of the invention to consider statistical data from one or more fuel cell systems to analyze the complete fuel cell network or a portion thereof. The processing subsystem may, for example, track trends in temperature, pressure, purity, etc. Such trends may be indicative of changes that should be made to a fuel cell system. For example, a trend of increased contaminant in the hydrogen source may indicate an impending fuel cell failure, which may be prevented by remotely ceasing fuel cell system operation by sending appropriate command signals from the remote servicing system to the fuel cell system.

Centralizing the servicing of a plurality of fuel cell systems may increase the overall effectiveness of the fuel cell network. For example, the remote servicing system may use real time or compiled data regarding the failure of one fuel cell system to prevent impending failures of other fuel cell systems. When one fuel cell system fails in response to a certain condition, the remote servicing system may send a command to avoid similar failures in other fuel cell systems, such as commands that adjust the operating state of the fuel cell systems. Without a central system for monitoring/controlling, this type of automatic analysis and prevention is not readily available. Another potential advantage is that each fuel cell system does not require constant on-site servicing, and instead a plurality of systems may be serviced by the same remote servicing system. Accordingly, a fewer number of technicians may be required for manual reactions or adjustments to operating parameters of the fuel cell systems. Yet another potential advantage is that the fuel cell systems may be used by individuals that are not trained in the operation and/or servicing of the systems, with the safe operation and/or control of the systems being provided by the remote servicing system.

As discussed, fuel cell systems with a distributed fuel cell network according to the present invention may be used to backup and/or supplement the power produced by a primary power source, such as an electrical power grid, other fuel cell system or network, etc. that is adapted to provide power to one or more energy-consuming devices and which may be located proximate or remotely to the RSS. For example, the RSS may detect an operating, or energy output state, or the primary power source and select an operating state for one or more fuel cell systems responsive to the energy output state of the primary power source. By way of illustration, if the primary power source is not providing power to one or more energy-consuming devices that are applying a load to the primary power source, the RSS may select an active operating state for one or more of the remote fuel cell systems with which it is in communication so that the one or more fuel cell systems provide power to the energy-consuming device(s). Similarly, if the primary power source is not able to meet the load, or demand, being applied thereto by the energy-consuming device(s), the RSS may also select an active operating state for the one or more fuel cell systems so that the systems may be used to supplement the power being produced by the primary power source. As a further example, if the RSS detects that the primary power source is (or begins) providing power (or providing sufficient power) to the energy-consuming devices responsive to a load applied by the device(s), then it may select a de-energized operating state for the one or more fuel cell systems so that the systems are not providing power to the energy-consuming devices. The selecting of the operating state for the fuel cell system or systems may be performed by the RSS via any mechanism described herein, including automated mechanism, manual mechanisms, or both, and will include sending operating instructions to the one or more fuel cell systems via the network communication subsystem.

Continuing the above illustrative examples, the RSS (such as the processing subsystem thereof), may additionally or alternatively monitor the current operating state of a primary power source (which may be located proximate or remotely to the RSS), and at least partially responsive to this information (such as the operating state generally or one or more operating parameters that at least partially define the operating state) determine a prospective operating state of the primary power source. The RSS may then select an operating state for one or more fuel cell systems with which it is in communication (such as via the network communication subsystem) based at least in part on the current and prospective operating states of the primary power source. For example, if the primary power source is providing power to one or more energy-consuming devices but the prospective operating state indicates that it will not be providing power to the device(s) to meet a load applied therefrom, the RSS may send operating instructions to one or more fuel cell systems to configure the system(s) to an operating state where the one or more systems are adapted to supply power to the at least one energy-consuming device. By this it is meant that the one or more fuel cell systems are started up or otherwise configured to provide power to the energy-consuming device(s) responsive to a load applied therefrom. As another example, if one or more fuel cell systems are providing power to one or more energy-consuming devices, the primary power source is currently not providing power to the device(s), and the prospective operating state of the primary power source is a state in which the primary power source is configured to provide power to the device(s), then the RSS may select an operating state for the one or more fuel cell systems in which the systems are not providing power to the device(s). Examples of this latter fuel cell system operating state include an operating state in which the one or more fuel cell systems are isolated from the electrical load applied by the energy-consuming device(s), shutdown, and/or transitioned to an idle state. Illustrative situations where such an embodiment may be utilized include when a primary power source is scheduled to be offline or otherwise not able to provide power to an energy-consuming device, and when a primary power source is brought back online, i.e. to an operating state where it is configured to provide power to the energy-consuming device(s) responsive to a load therefrom.

As still further illustrative examples, the RSS may be configured to monitor the operating state of a primary power source, recognize or otherwise detect an imminent and/or actual or prospective change in the operating state of the primary power source and transmit operating instructions to one or more fuel cell systems to select an operating state for the fuel cell system(s) in response to, or anticipation of, the change in the operating state of the primary power source. When the RSS sends operating instructions to the one or more fuel cell systems, such as responsive to the current (and/or prospective) operating state of a primary power source, the sending of command signals or other instructions may be preceded by the RSS determining the current operating state of the fuel cell system(s). For example, the selected operating state, or at least the particular operating instructions may be at least partially based upon or responsive to the current operating state of the fuel cell system. The determination of the current operating state of the one or more fuel cell systems may be made by sending a status query to the system(s) or through any other suitable mechanism, such as those described herein to communicate information between the RSS and one or more remote fuel cell systems.

The remote servicing system may remotely control sets of fuel cell systems 12 as a group when the respective operating states of the fuel cell systems require similar adjustments. For example, a set of the fuel cell systems of a fuel cell network may be instructed to shutdown or otherwise prepare to cease providing power to an energy-consuming device in anticipation of power being restored by an electric utility, after a power failure, for instance. Similarly, the fuel cell systems may be instructed to startup and begin operation in anticipation of a scheduled power outage or detection of an unexpected outage of a primary power supply (or primary power source), such as an electrical power grid, another fuel cell system, fuel cell systems or fuel cell network, or other source of power. Centralized control increases the efficiency, safety, and ease of operation of the fuel cell network. Without such centralized control, each fuel cell system within the network would have to be individually started up and shut down, which may require a knowledgeable technician at each fuel cell system location. Furthermore, there would be no direct mechanism for receiving information regarding power outages or other problems for which early warning is valuable to the fuel cell system.

FIG. 8 illustrates an example of a redundantly controlled fuel cell network 10. By “redundantly controlled,” it is meant that the network includes at least one fuel cell system that is configured to be serviced by two or more remote servicing systems. In some embodiments, more than one remote servicing system may be responsible for a particular fuel cell system, with each remote servicing system being configured to provide the same level of servicing to the fuel cell system. For example, two or more remote servicing systems, such as systems 34 and 36, may be configured to provide one or more fuel cell systems with redundant servicing, so that if one remote servicing system fails, the remaining remote servicing system may continue to service the fuel cell systems, thereby maintaining uninterrupted servicing of the systems. Remote servicing systems of a redundantly controlled fuel cell network may be similarly configured to provide the same servicing, or may alternatively be differently configured. For example, systems 34 and 36 may be configured to provide the same servicing of the remote fuel cell systems to provide a backup remote servicing system. Therefore, if one RSS 34 or 36 fails, the remote fuel cell systems will still be serviced by the other RSS. As another example, remote servicing system 34 may be configured for control and monitoring, while remote servicing system 36 is minimally configured to provide essential support in the event of a failure of RSS 34. It is also within the scope of the invention for one RSS to provide one type of servicing to the fuel cell network, while another RSS provides different servicing. For example, RSS 34 may provide monitoring servicing, while RSS 36 provides control servicing.

In some embodiments, backup remote servicing systems may provide purely backup service, thereby only servicing fuel cell systems if a primary remote servicing system fails. In other embodiments, primary remote servicing systems may backup other primary remote servicing systems, and therefore function as a backup remote servicing system. An example of such a distributed fuel cell network 10 is shown in FIG. 9. As shown, a remote servicing system 34 is primarily responsible for a set 12 of networked fuel cell system(s), and another remote servicing system 36, is primarily responsible for another set 12′ of remote fuel cell systems. Remote servicing system 36 is configured to provide backup service to remote servicing system 34, in the event remote servicing system 34 fails. Therefore, if RSS 34 fails, remote fuel cell systems 12 will still be serviced by remote servicing system 36. Similarly, if remote servicing system 36 fails, fuel cell systems 12′ may be serviced by remote servicing system 34. Backup remote servicing systems may be configured to provide the same level of service as primary remote servicing systems, or in some embodiments, the backup remote servicing systems may be minimally configured to provide only essential support in the event of a failure of a primary remote servicing system.

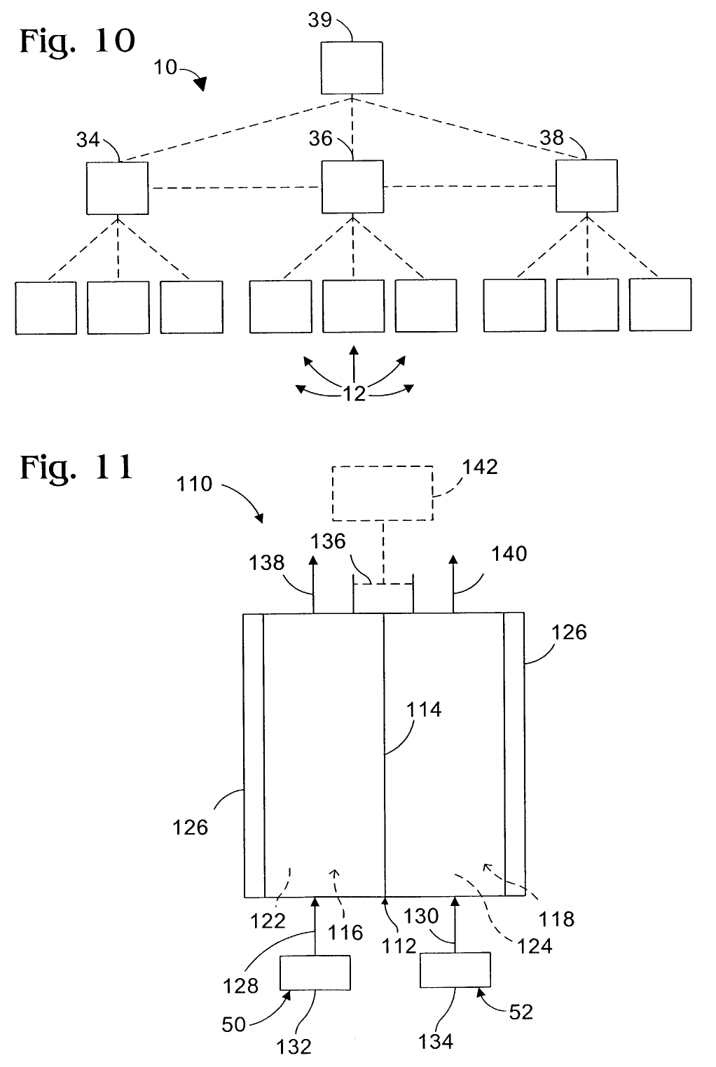

Another example of a redundantly controlled fuel cell network is shown in FIG. 10. As shown, three remote servicing systems 34, 36 and 38 are shown, with each RSS being configured to provide primary servicing of one or more fuel cell systems 12. The illustrated fuel cell network further includes another remote servicing system 39, which communicates with remote servicing systems 34-38. In such an embodiment, RSS 39 does not provide primary servicing of any fuel cell systems, and instead provides backup servicing to all of the fuel cell systems. RSS may also be configured to provide servicing to remote servicing systems 34-38. For example, if one of remote servicing systems 34-38 fails or otherwise is offline, RSS 39 may itself provide servicing to the fuel cell systems that previously were serviced by that remote servicing system. RSS 39 may also send a command signal to one of the other remote servicing systems instructing that RSS to take over primary servicing of the fuel cell systems.

Fuel cell stack 48 typically includes a plurality of fuel cells. The fuel cells, or fuel cell assemblies are physically arranged between opposing end plates. Each cell is individually configured to convert a fuel and an oxidant into an electric current. The fuel cells are usually electrically coupled in series, although it is within the scope of the invention to couple the cells in parallel or in a combination of series and parallel. When electrically coupled, the cells collectively provide an electric potential dependent on the configuration of the stack. For example, if all cells are electrically coupled in series, the electric potential provided by the stack is the sum of the cells' respective potentials. Stack 48 may include positive and negative contacts across which a load may be electrically coupled. It should be understood that the number of fuel cells in any particular stack may be selected depending upon the desired power output of the fuel cell stack.

Fuel cell systems of the present invention may incorporate any suitable type of fuel cells, such as proton exchange membrane (PEM) fuel cells, alkaline fuel cells, solid oxide fuel cells, phosphoric acid fuel cells, molten carbonate, and the like. For the purpose of illustration, an exemplary fuel cell in the form of a PEM fuel cell is schematically illustrated in FIG. 11 and generally indicated at 110. Proton exchange membrane fuel cells typically utilize a membrane-electrode assembly (MEA) 112 than includes an ion exchange, or electrolytic, membrane 114 located between an anode region 116 and a cathode region 118. Each region 116 and 118 includes an electrode, namely an anode 122 and a cathode 124, respectively. Each region 116 and 118 also includes a supporting plate 126, which is typically configured to act as a charge path between adjacent MEAs and physically support adjacent MEAs. In fuel cell stack 48, the supporting plates 126 of adjacent fuel cells are often united to form a bipolar plate separating the adjacent MEAs.

In operation, hydrogen 128 is fed to the anode region, while oxygen 130 is fed to the cathode region. Hydrogen 128 and oxygen 130 may be delivered to the respective regions of the fuel cell from a suitable fuel source 50 and oxidant source 52 via any suitable mechanisms. In the illustrated embodiment, fuel source 50 includes a source 132 of hydrogen gas, and oxidant source 52 includes a source 134 of oxygen. Examples of suitable sources 132 for hydrogen 128 include a pressurized tank, hydride bed or other suitable hydrogen storage device, and/or a fuel processor that produces a stream containing hydrogen gas. Examples of suitable sources 134 of oxygen 130 include a pressurized tank of oxygen, air, or oxygen-enriched air, or a fan, compressor, blower, or other device for directing air to the cathode region. Hydrogen and oxygen typically combine with one another via an oxidation-reduction reaction. Although membrane 114 restricts the passage of a hydrogen molecule, it will permit a hydrogen ion (proton) to pass therethrough, largely due to the ionic conductivity of the membrane. The free energy of the oxidation-reduction reaction drives the proton from the hydrogen gas through the ion exchange membrane. As membrane 114 also tends not to be electrically conductive, an external circuit 136 is the lowest energy path for the remaining electron, and is schematically illustrated in FIG. 11. In cathode region 118, electrons from the external circuit and protons from the membrane combine with oxygen to produce water and heat. Also shown in FIG. 11 are an anode purge stream 138, which may contain hydrogen gas, and a cathode air exhaust stream 140, which is typically at least partially, if not substantially, depleted of oxygen. It should be understood that fuel cell stack 48 will typically have a common hydrogen (or other reactant) feed, air intake, and stack purge and exhaust streams, and accordingly will include suitable fluid conduits to deliver the associated streams to, and collect the streams from, the individual cells.

In practice, a fuel cell stack contains a plurality of fuel cells with bipolar plate assemblies separating adjacent membrane-electrode assemblies. The bipolar plate assemblies essentially permit the free electron to pass from the anode region of a first cell to the cathode region of the adjacent cell via the bipolar plate assembly, thereby establishing an electrical potential through the stack that may be used to satisfy an applied load. At least one energy-consuming device 142 may be electrically coupled to the fuel cell, or more typically, the fuel cell stack. Device 142 applies a load to the cell/stack and draws an electric current therefrom to satisfy the load. Illustrative examples of devices 142 include motor vehicles, recreational vehicles, boats and other seacraft, tools, lights and lighting assemblies, signaling and communications equipment, batteries, and even the balance-of-plant electrical requirements for the fuel cell system of which stack 48 forms a part.

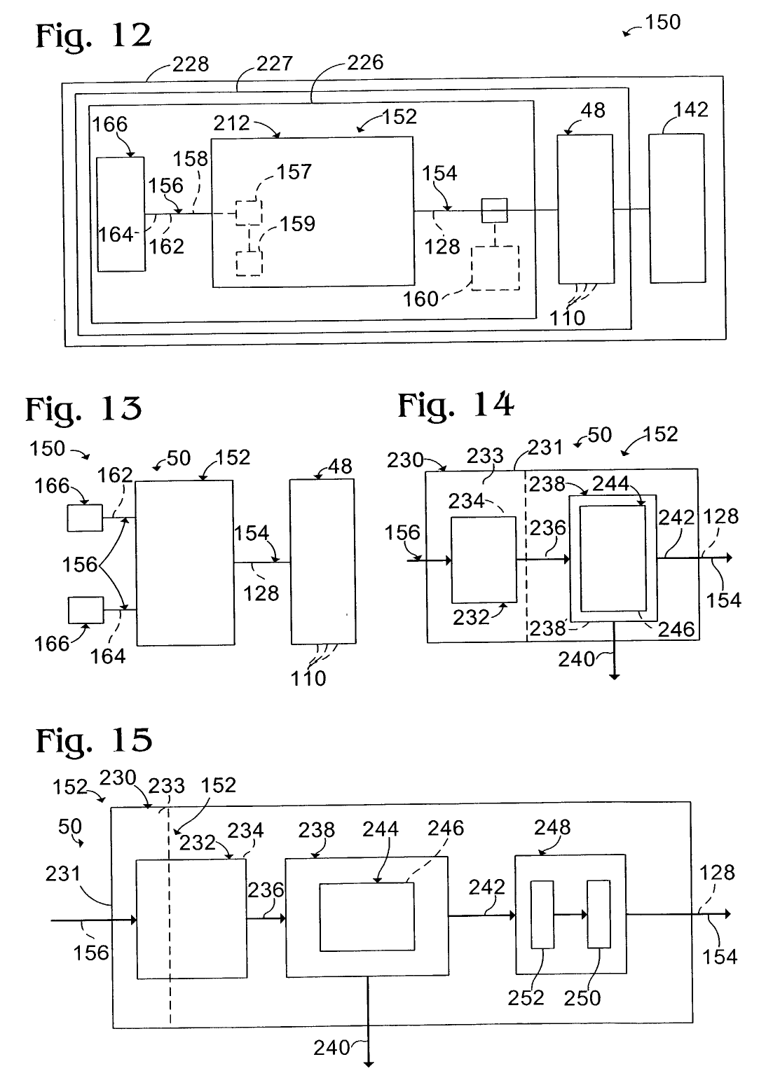

As discussed above, fuel cell system 12 includes a fuel source 50, such as a source 132 of hydrogen gas 128. As also discussed, an example of a suitable source 132 is a fuel processor that is adapted to produce a product stream of at least substantially pure hydrogen gas 128. An illustrative example of such a fuel cell system 12 is shown in FIG. 12 and generally indicated at 150. System 150 includes at least one fuel processor 152 and at least one fuel cell stack 48. Fuel processor 152 is adapted to produce a product hydrogen stream 154 containing hydrogen gas 128 from a feed stream 156 containing at least one feedstock 158. The fuel cell stack is adapted to produce an electric current from the portion of product hydrogen stream 154 delivered thereto. In the illustrated embodiment, a single fuel processor 152 and a single fuel cell stack 48 are shown; however, it is within the scope of the invention that more than one of either or both of these components may be used. It should be understood that these components have been schematically illustrated and that the fuel cell system may include additional components that are not specifically illustrated in the Figures, such as air delivery systems, heat exchangers, heating assemblies and the like. For example, some fuel processors are adapted to produce product hydrogen stream 154 from a vaporized (or gaseous) feed stream 156. In such an embodiment, the feed stream may be delivered to the fuel processor in a vaporized (or gaseous) state, or alternatively the fuel processor may include a vaporization region 157 in which the feed stream is vaporized, such as by a suitable burner or other heating assembly 159, as indicated in dashed lines in FIG. 12.

In the illustrative embodiment shown in FIG. 12, hydrogen gas may be delivered to stack 48 from one or more of fuel processor 152 and a hydrogen storage device 160, which may include any suitable structure for storing hydrogen gas. Examples of suitable structures include hydride beds and pressurized tanks. As also shown in the illustrative embodiment shown in FIG. 12, hydrogen 128 from the fuel processor may be delivered to one or more of the storage device and stack 48. Some or all of stream 154 may additionally, or alternatively, be delivered, via a suitable conduit, for use in another hydrogen-consuming process, burned for fuel or heat, or stored for later use.

Fuel processor 152 is any suitable device that produces from the feed stream a stream (such a product hydrogen stream 154) that contains at least substantially hydrogen gas. Examples of suitable mechanisms for producing hydrogen gas from feed stream 156 include steam reforming and autothermal reforming, in which reforming catalysts are used to produce hydrogen gas from a feed stream containing a carbon-containing feedstock and water. Other suitable mechanisms for producing hydrogen gas include pyrolysis and catalytic partial oxidation of a carbon-containing feedstock, in which case the feed stream does not contain water. Still another suitable mechanism for producing hydrogen gas is electrolysis, in which case the feedstock is water. Examples of suitable carbon-containing feedstocks include at least one hydrocarbon or alcohol. Examples of suitable hydrocarbons include methane, propane, natural gas, diesel, kerosene, gasoline and the like. Examples of suitable alcohols include methanol, ethanol, and polyols, such as ethylene glycol and propylene glycol.

Feed stream 156 may be delivered to fuel processor 152 via any suitable mechanism. Although only a single feed stream 156 is shown in FIG. 12, it should be understood that more than one stream 156 may be used and that these streams may contain the same or different feedstocks. For example, when fuel processor 152 is adapted to receive a feedstock 158 that includes a carbon-containing feedstock 162 and water 164, the carbon-containing feedstock and water may be delivered in separate feed streams or in the same feed stream. For example, when the carbon-containing feedstock is miscible with water, the feedstock is typically, but not required to be, delivered with the water component of feed stream 156, such as shown in FIG. 12. When the carbon-containing feedstock is immiscible or only slightly miscible with water, these feedstocks are typically delivered to fuel processor 152 in separate streams, such as shown in FIG. 13. In FIGS. 12 and 13, feed stream 156 is shown being delivered to fuel processor 152 by a feedstock delivery system 166, which may be any suitable pump, compressor, and/or flow-regulating device that selectively delivers the feed stream to the fuel processor.

It is desirable for the fuel processor to produce at least substantially pure hydrogen gas. Accordingly, the fuel processor may utilize a process that inherently produces sufficiently pure hydrogen gas, or the fuel processor may include suitable purification and/or separation devices that remove impurities from the hydrogen gas produced in the fuel processor. As another example, the fuel processing system or fuel cell system may include purification and/or separation devices downstream from the fuel processor. In the context of a fuel cell system, the fuel processor preferably is adapted to produce substantially pure hydrogen gas, and even more preferably, the fuel processor is adapted to produce pure hydrogen gas. For the purposes of the present invention, substantially pure hydrogen gas is greater than 90% pure, preferably greater than 95% pure, more preferably greater than 99% pure, and even more preferably greater than 99.5% pure. Suitable fuel processors are disclosed in U.S. Pat. Nos. 6,221,117, 5,997,594, 5,861,137, and pending U.S. patent application Ser. No. 09/802,361. The complete disclosures of the above-identified patents and patent application are hereby incorporated by reference for all purposes.

For purposes of illustration, the following discussion will describe fuel processor 152 as a steam reformer adapted to receive a feed stream 156 containing a carbon-containing feedstock 162 and water 164. However, it is within the scope of the invention that fuel processor 152 may take other forms, as discussed above. An example of a suitable steam reformer is shown in FIG. 14 and indicated generally at 230. Reformer 230 includes a reforming, or hydrogen-producing, region 232 that includes a steam reforming catalyst 234. Alternatively, reformer 230 may be an autothermal reformer that includes an autothermal reforming catalyst. In reforming region 232, a reformate stream 236 is produced from the water and carbon-containing feedstock in feed stream 156. The reformate stream typically contains hydrogen gas and other gases. In the context of a fuel processor generally, a mixed gas stream that contains hydrogen gas and other gases is produced from the feed stream. The mixed gas, or reformate, stream is delivered to a separation region, or purification region, 238, where the hydrogen gas is purified. In separation region 238, the hydrogen-containing stream is separated into one or more byproduct streams, which are collectively illustrated at 240 and which typically include at least a substantial portion of the other gases, and a hydrogen-rich stream 242, which contains at least substantially pure hydrogen gas. The separation region may utilize any separation process, including a pressure-driven separation process. In FIG. 14, hydrogen-rich stream 242 is shown forming product hydrogen stream 154.

An example of a suitable structure for use in separation region 238 is a membrane module 244, which contains one or more hydrogen permeable membranes 246. Examples of suitable membrane modules formed from a plurality of hydrogen-selective metal membranes are disclosed in U.S. Pat. No. 6,319,306, the complete disclosure of which is hereby incorporated by reference for all purposes. In the '306 patent, a plurality of generally planar membranes are assembled together into a membrane module having flow channels through which an impure gas stream is delivered to the membranes, a purified gas stream is harvested from the membranes and a byproduct stream is removed from the membranes. Gaskets, such as flexible graphite gaskets, are used to achieve seals around the feed and permeate flow channels. Also disclosed in the above-identified application are tubular hydrogen-selective membranes, which also may be used. Other suitable membranes and membrane modules are disclosed in the above-incorporated patents and applications, as well as U.S. patent application Ser. Nos. 10/067,275 and 10/027,509, the complete disclosures of which are hereby incorporated by reference in their entirety for all purposes. Membrane(s) 246 may also be integrated directly into the hydrogen-producing region or other portion of fuel processor 152.

The thin, planar, hydrogen-permeable membranes are preferably composed of palladium alloys, most especially palladium with 35 wt % to 45 wt % copper, such as approximately 40 wt % copper. These membranes, which also may be referred to as hydrogen-selective membranes, are typically formed from a thin foil that is approximately 0.001 inches thick. It is within the scope of the present invention, however, that the membranes may be formed from hydrogen-selective metals and metal alloys other than those discussed above, hydrogen-permeable and selective ceramics, or carbon compositions. The membranes may have thicknesses that are larger or smaller than discussed above. For example, the membrane may be made thinner, with commensurate increase in hydrogen flux. The hydrogen-permeable membranes may be arranged in any suitable configuration, such as arranged in pairs around a common permeate channel as is disclosed in the incorporated patent applications. The hydrogen permeable membrane or membranes may take other configurations as well, such as tubular configurations, which are disclosed in the incorporated patents. Another example of a suitable pressure-separation process for use in separation region 238 is pressure swing adsorption (PSA). In a pressure swing adsorption (PSA) process, gaseous impurities are removed from a stream containing hydrogen gas. PSA is based on the principle that certain gases, under the proper conditions of temperature and pressure, will be adsorbed onto an adsorbent material more strongly than other gases. Typically, it is the impurities that are adsorbed and thus removed from reformate stream 236.

As discussed, it is also within the scope of the invention that at least some of the purification of the hydrogen gas is performed intermediate the fuel processor and the fuel cell stack. Such a construction is schematically illustrated in dashed lines in FIG. 14, in which the separation region 238′ is depicted downstream from the shell 231 of the fuel processor.

Reformer 230 may, but does not necessarily, additionally or alternatively, include a polishing region 248, such as shown in FIG. 15. As shown, polishing region 248 receives hydrogen-rich stream 242 from separation region 238 and further purifies the stream by reducing the concentration of, or removing, selected compositions therein. For example, compositions that may damage fuel cell stack 48, such as carbon monoxide and carbon dioxide, may be removed from the hydrogen-rich stream. The concentration of carbon monoxide should be less than 10 ppm (parts per million). Preferably, the system limits the concentration of carbon monoxide to less than 5 ppm, and even more preferably, to less than 1 ppm. The concentration of carbon dioxide may be greater than that of carbon monoxide. For example, concentrations of less than 25% carbon dioxide may be acceptable. Preferably, the concentration is less than 10%, and even more preferably, less than 1%. Especially preferred concentrations are less than 50 ppm. It should be understood that the acceptable maximum concentrations presented herein are illustrative examples, and that concentrations other than those presented herein may be used and are within the scope of the present invention. For example, particular users or manufacturers may require minimum or maximum concentration levels or ranges that are different than those identified herein. Similarly, when fuel processor 152 is used with a fuel cell stack that is more tolerant of these impurities, then the product hydrogen stream may contain larger amounts of these gases.

Region 248 includes any suitable structure for removing or reducing the concentration of the selected compositions in stream 242. For example, when the product stream is intended for use in a PEM fuel cell stack or other device that will be damaged if the stream contains more than determined concentrations of carbon monoxide or carbon dioxide, it may be desirable to include at least one methanation catalyst bed 250. Bed 250 converts carbon monoxide and carbon dioxide into methane and water, both of which will not damage a PEM fuel cell stack. Polishing region 248 may (but is not required to) also include another hydrogen-producing device 252, such as another reforming catalyst bed, to convert any unreacted feedstock into hydrogen gas. In such an embodiment, it is preferable that the second reforming catalyst bed is upstream from the methanation catalyst bed so as not to reintroduce carbon dioxide or carbon monoxide downstream of the methanation catalyst bed.

Steam reformers typically operate at temperatures in the range of 200° C. and 800° C., and at pressures in the range of 50 psi and 1000 psi, although temperatures and pressures outside of these ranges are within the scope of the invention, such as depending upon the particular type and configuration of fuel processor being used. Any suitable heating mechanism or device may be used to provide this heat, such as a heater, burner, combustion catalyst, or the like. The heating assembly may be external the fuel processor or may form a combustion chamber that forms part of the fuel processor. The fuel for the heating assembly may be provided by the fuel processing system, by the fuel cell system, by an external source, or any combination thereof.

In FIGS. 14 and 15, reformer 230 is shown including a shell 231 in which the above-described components are contained. Shell 231, which also may be referred to as a housing, enables the fuel processor, such as reformer 230, to be moved as a unit. It also protects the components of the fuel processor from damage by providing a protective enclosure and reduces the heating demand of the fuel processor because the components of the fuel processor may be heated as a unit. Shell 231 may, but does not necessarily, include insulating material 233, such as a solid insulating material, blanket insulating material, or an air-filled cavity. It is within the scope of the invention, however, that the reformer may be formed without a housing or shell. When reformer 230 includes insulating material 233, the insulating material may be internal the shell, external the shell, or both. When the insulating material is external a shell containing the above-described reforming, separation and/or polishing regions, the fuel processor may further include an outer cover or jacket external the insulation.

It is further within the scope of the invention that one or more of the components may either extend beyond the shell or be located external at least shell 231. For example, and as schematically illustrated in FIG. 15, polishing region 248 may be external shell 231 and/or a portion of reforming region 232 may extend beyond the shell. Other examples of fuel processors demonstrating these configurations are illustrated in the incorporated references and discussed in more detail herein.

Although fuel processor 152, feedstock delivery system 166, fuel cell stack 48 and energy-consuming device 142 may all be formed from one or more discrete components, it is also within the scope of the invention that two or more of these devices may be integrated, combined or otherwise assembled within an external housing or body. For example, a fuel processor and feedstock delivery system may be combined to provide a hydrogen-producing device with an on-board, or integrated, feedstock delivery system, such as schematically illustrated at 226 in FIG. 12. Similarly, a fuel cell stack may be added to provide an energy-generating device with an integrated feedstock delivery system, such as schematically illustrated at 227 in FIG. 12.

Fuel cell system 12 may additionally be combined with an energy-consuming device, such as device 142, to provide the device with an integrated, or on-board, energy source. For example, the body of such a device is schematically illustrated in FIG. 12 at 228. Examples of such devices include a motor vehicle, such as a recreational vehicle, automobile, boat or other seacraft, and the like, a dwelling, such as a house, apartment, duplex, apartment complex, office, store or the like, or self-contained equipment, such as an appliance, light, tool, microwave relay station, transmitting assembly, remote signaling or communication equipment, etc.

To simplify the illustrative fuel cell systems and fuel processors shown in FIGS. 12-15, the components of FCS communication subsystem 42, measurement subsystem 44 and local controller 46 have not been illustrated. Typically, these subsystems and/or controller will be either commonly housed with at least one of the above-described components of the fuel cell system or fuel processor, or located directly proximate thereto. It should be understood that the measurement subsystem will include various sensors, or assemblies of sensors placed in suitable positions for detecting the corresponding operating parameter to be measured. Similarly, local controller 46 will include suitable control linkages or actuators configured to respond to a control signal from the local controller and/or RSS to initiate a desired response from the fuel cell system. Illustrative, non-exclusive examples of sensor positions and control linkages/actuators are disclosed in U.S. Pat. Nos. 6,451,464, 6,383,670, 6,375,906, and 6,242,120, and in U.S. patent application Ser. Nos. 09/626,311 and 09/815,180, the complete disclosures of which are hereby incorporated by reference.

It is within the scope of the invention that the various subsystems, units, devices, etc. discussed herein may, in some embodiments, share components such as processors, busses, power supplies, communication linkages, etc. with each other. In this manner, a single component may be utilized by more than one subsystem.

For the purpose of illustration, the following table provides non-exclusive examples of situations in which the remote servicing system monitors and controls the operation of a fuel cell system. In particular, the left column of the table includes exemplary measured conditions that may be monitored by a RSS and/or transmitted to the RSS by a fuel cell system. The right column of the table includes corresponding responses that the remote servicing system may transmit to the fuel cell system, such as via one or more communication signals including one or more command signals.

To simplify the following table and discussion, the interaction between the RSS and a fuel cell system is often described herein as being a one-to-one interaction, however, RSS 30 may service a plurality of fuel cell systems, individually or as a group. As discussed, the examples presented in the table are not intended to be an exclusive list of monitored events or responses thereto. Accordingly, the RSS may provide all, only a subset, or only one of the illustrative responses when more than one response is provided in the following table. It is also within the scope of the invention that the RSS may additionally or alternatively provide responses that are not listed in the illustrative examples presented below without departing from the spirit and scope of the present invention. Similarly, it is also not required that a distributed fuel cell network according to the present invention implement all of the below-presented examples.

| | ILLUSTRATIVE RSS |
|---|---|
| MONITORED EVENT | RESPONSES |
| supply of feedstock for fuel | notification, isolate fuel cell |
| processor feed stream exhausted | stack, shutdown fuel processor |
| | and/or fuel cell system, utilize |
| | stored supply of hydrogen gas |
| | from hydrogen storage device or |
| | external source |
| low feedstock in supply for fuel | notification, ramp down fuel |
| processor feed stream | processor and/or fuel cell system, |
| | transition fuel processor to idle |
| | state, supplement flow of product |
| | hydrogen stream from a stored |
| | supply of hydrogen gas or |
| | external supply |
| flow of feed stream to fuel | notification, supplement flow of |
| processor outside of acceptable | product hydrogen stream, utilized |
| range | stored supply of hydrogen gas, |
| | shutdown fuel processor and/or |
| | fuel cell system, isolate fuel cell |
| | stack, shutdown fuel processor |
| | and/or fuel cell system |
| no feed stream, or feed stream | notification, shutdown fuel |
| component being supplied to fuel | processor and/or fuel cell system, |
| processor | utilize stored supply of hydrogen |
| | gas, isolate fuel cell stack |
| composition of feed stream | notification, transition fuel |
| exceeds acceptable range | processor to idle state, shutdown |
| | fuel processor and/or fuel cell |
| | system, isolate fuel cell stack, |
| | ramp fuel processor up or down, |
| | adjust mix ratio of feed stream, |
| | adjust temperature of feed stream |
| | and/or fuel processor |
| temperature of fuel processor (or | notification, adjust flow rate of |
| region thereof) exceeds | coolant streams, transition fuel |
| acceptable range | processor to idle state, ramp fuel |
| | processor up or down, ramp |
| | burner or other heating assembly |
| | for fuel processor up or down, |
| | shutdown fuel processor and/or |
| | fuel cell system |
| pressure of fuel processor (or | notification, adjust pressure of |
| region thereof) exceeds | feed stream, adjust temperature of |
| acceptable range | feed stream, transition fuel |
| | processor to idle state, ramp fuel |
| | processor up or down, shutdown |
| | fuel processor and/or fuel cell |
| | system |
| ignition (initial or continuing) not | notification, isolate fuel cell |
| detected in combustion | stack, attempt reignition, |
| region/heater | shutdown fuel processor or fuel |
| | cell system, transition fuel |
| | processor to idle state |
| hydrogen production rate exceeds | ramp down fuel processor, vent |
| demand | excess hydrogen gas, divert |
| | excess hydrogen gas to external |
| | source, combust excess hydrogen |
| | gas, store excess hydrogen gas |
| impurity detected in product | notification, isolate fuel cell |
| hydrogen stream | stack, shutdown fuel processor |
| | and/or fuel cell system, utilize |
| | stored supply of hydrogen gas or |
| | hydrogen gas from an external |
| | source |
| applied load to fuel cell stack | notification, regulate load, isolate |
| exceeds maximum rated output | fuel cell stack |
| applied load to fuel cell stack | notification, regulate load, ramp |
| exceeds maximum available | up fuel processor, utilize stored |
| output | supply of hydrogen gas or |
| | hydrogen gas from an external |
| | source |
| battery reservoir fully charged | ramp down fuel processor, divert |
| | excess power to electrical grid or |
| | other energy-consuming, transfer |
| | or storage device |
| stored charge in battery reservoir | notification, ramp up fuel |
| depleted to minimum threshold | processor, regulate load |
| stored charge in battery reservoir | notification, regulate load, ramp |
| depleted | up fuel processor, isolate fuel cell |
| | stack, shutdown fuel cell system |
| temperature of battery reservoir | notification, regulate load, isolate |
| exceeds acceptable range | battery reservoir, isolate fuel cell |
| | stack, shutdown fuel cell system |
| loss of communication with local | notification, shutdown fuel cell |
| controller | system from RSS, control fuel |
| | cell system from RSS |
| malfunctioning flow regulator | notification, adjust flow rates to |
| (valve, switch, vent, etc.) in fuel | compensate for malfunctioning |
| or component thereof | flow regulator, shutdown fuel |
| | processor and/or fuel cell system, |
| | transition fuel processor to idle |
| | state, isolate fuel cell stack |
| excess water detected in fuel cell | purge fuel cell stack, adjust flow |
| stack | rate of oxidant source |
| weak/malfunctioning cell | notification, regulate load, isolate |
| detected in fuel cell stack | fuel cell stack, shutdown fuel cell |
| | system |
| malfunction of oxidant source | notification, isolate fuel cell |
| | stack, shutdown fuel cell system |
| flow of oxidant (air) exceeds | notification, adjust flow rate of |
| acceptable range | oxidant, shutdown fuel cell |
| | system |
| loss of communication with fuel | notification, attempt shutdown of |
| cell system | fuel cell system (such as in case |
| | communication from RSS to the |
| | fuel cell system still exists) |
| loss of contact with primary | notification, startup fuel cell |
| power source | system |
| primary power source no longer | notification, startup fuel cell |
| producing electricity | system |
| primary power source offline | notification, startup fuel cell |
| | system |
| detection of primary power | notification, isolate fuel cell |
| source returning online | stack, transition fuel processor to |
| | idle state, shutdown fuel cell |
| | system |
| detection of primary power | notification, isolate fuel cell |
| source producing electricity | stack, transition fuel processor to |
| | idle state, shutdown fuel cell |
| | system |
| none | startup fuel cell system |
| none | shutdown fuel cell system |
| none | adjust flow rate of feed stream to |
| | fuel processor |
| none | adjust composition of feed stream |
| | to fuel processor |
| none | adjust temperature of feed stream |
| | to fuel processor |
| none | adjust temperature of fuel |
| | processor, such as by controlling |
| | the heating assembly, flow of heat |
| | exchange streams, cooling |
| | assembly, etc. |
| none | divert a selected portion of the |
| | product hydrogen stream to an |
| | external source, hydrogen storage |
| | device, combustion unit, or vent |
| none | transition fuel processor to idle |
| | state |
| none | transition fuel processor form idle |
| | state to hydrogen-producing state |
| none | adjust pressure of feed stream |
| none | adjust pressure of product |
| | hydrogen stream |
| none | adjust flow of oxidant to fuel cell |
| | stack |
| none | purge fuel cell stack |
| none | regulate load applied to fuel cell |
| | stack |
| none | isolate fuel cell stack |

As used herein, when an operating parameter is described as being outside of an acceptable range, it is meant that the operating parameter exceeds a predetermined, or preset or existing, value or range of values. Therefore, the operating parameter may exceed the value or range of values, may be less than the value or range of values, or deviate from the value or range of values by more than a predetermined, or preset tolerance, such as 1%, 2%, 5%, 10%, 25%, etc. The above references to isolating the fuel cell stack or the fuel cell system means that a switch, contactor, or other suitable connection is actuated to prevent a load from being applied to the fuel cell stack, such as from device 142. Similarly, the references to regulating load refer the controlling the electrical or other load that is applied to the fuel cell stack. The above references to “notification” refer to sending a notification or otherwise contacting a technician or designated representative about the monitored event. The preceding references to ramping a fuel processor up or down respectively refer to increasing or decreasing the rate at which the fuel processor produces hydration gas. Similarly, ramping up or down the fuel cell system refers to increased or decreasing the power produced thereby. The idle state referred to above refers to an operating state where the fuel processor is available (heated, etc.) to produce at least a substantial, if not the entire, amount of its maximum output, but only a relatively low flow of the feed stream is delivered to the fuel processor. Accordingly, only a small flow rate of product hydrogen stream is produced, with this stream often being utilized as a combustible fuel to maintain the fuel processor at its desired operating temperature. As such, the idle state may also be referred to as a standby state, in that the fuel processor is available to produce a substantial portion, if not its entire, maximum output of hydrogen gas responsive only to the receipt of a sufficient flow of the appropriate feed stream. Ramping up the fuel processor may include transitioning the fuel processor from an idle, or shutdown operating state to a hydrogen-producing state. Illustrative examples of the startup, idle, hydrogen-producing and other illustrative operating states of a fuel processor are disclosed in the above-incorporated U.S. Pat. No. 6,383,670.

### INDUSTRIAL APPLICABILITY

The invented fuel cell network, methods of fuel cell networking, and fuel cell systems and remote servicing systems configured for use in such fuel cell networks are applicable to the fuel processing, fuel cell and other industries in which fuel cells are utilized.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

I claim:

1 A distributed fuel cell network, comprising:
at least one fuel cell system, comprising:
a fuel cell stack configured to produce an electric current from a fuel and an oxidant;
a measurement subsystem adapted to measure one or more operating parameters of the fuel cell system, wherein the one or more operating parameters at least partially define an operating state of the fuel cell system; and
a fuel cell system communication subsystem in communication with the measurement subsystem and configured to transmit the one or more operating parameters to a remote servicing system; and
a remote servicing system remotely located relative to the at least one fuel cell system, the remote servicing system comprising:
a remote servicing system communication subsystem configured to receive the one or more operating parameters transmitted from the at least one fuel cell system; and
a processing subsystem in communication with the remote servicing system and adapted to service the at least one fuel cell system at least partially in response to the one or more operating parameters transmitted from the at least one fuel cell system.

2. The distributed fuel cell network of claim 1, wherein the remote servicing system is configured to selectively transmit operating instructions to the at least one fuel cell system, and further wherein the at least one fuel cell system is configured to alter its operating state at least partially in response to operating instructions received from the remote servicing system.

3. The distributed fuel cell network of claim 1, wherein the servicing includes analyzing the one or more operating parameters to predict a future operating state of the at least one fuel cell system.

4. The distributed fuel cell network of claim 3, wherein the servicing further includes sending operating instructions to the at least one fuel cell system at least partially in response to the one or more operating parameters received from the at least one fuel cell system.

5. The distributed fuel cell network of claim 1, wherein the servicing includes analyzing the one or more operating parameters to predict a future deviation of the at least one fuel cell system from the operating state.

6. The distributed fuel cell network of claim 5, wherein the servicing further includes sending operating instructions to the at least one fuel cell system at least partially in response to the one or more operating parameters received from the at least one fuel cell system.

7. The distributed fuel cell network of claim 1, wherein the servicing includes analyzing the one or more operating parameters over time to predict a future operating state of the at least one fuel cell system.

8. The distributed fuel cell network of claim 7, wherein the servicing further includes sending operating instructions to the at least one fuel cell system at least partially in response to the one or more operating parameters received from the at least one fuel cell system.

9. The distributed fuel cell network of claim 1, wherein the servicing includes displaying via a user interface information corresponding to the one or more operating parameters.

10. The distributed fuel cell network of claim 9, wherein the servicing further includes receiving one or more user inputs at the remote servicing system and sending operating instructions to the at least one fuel cell system responsive at least in part to the user inputs.

11. The distributed fuel cell network of claim 1, wherein the servicing includes storing the transmitted one or more operating parameters.

12. The distributed fuel cell network of claim 1, wherein the servicing includes sending operating instructions to the at least one fuel cell system.

13. The distributed fuel cell network of claim 1, wherein the servicing includes sending operating instructions to the at least one fuel cell system responsive at least in part to the one or more operating parameters received from the at least one fuel cell system.

14. The distributed fuel cell network of claim 1, wherein each fuel cell system includes a local controller adapted to service the fuel cell system.

15. The distributed fuel cell network of claim 14, wherein the local controller is adapted to communicate with the remote servicing system.

16. The distributed fuel cell network of claim 1, wherein the fuel cell network includes a plurality of fuel cell systems.

17. The distributed fuel cell network of claim 16, wherein each of the plurality of fuel cell systems is remotely located relative to the remote servicing system.

18. The distributed fuel cell network of claim 17, wherein the network further includes at least one local fuel cell system proximately located relative to the remote servicing system.

19. The distributed fuel cell network of claim 16, wherein each of the plurality of fuel cell systems is remotely located relative to the other fuel cell systems.

20. The distributed fuel cell network of claim 1, wherein the at least one fuel cell system is physically separated from the remote servicing system and in communication therewith via at least one communication linkage.

21. The distributed fuel cell network of claim 20, wherein the at least one communication linkage includes a wired communication network.

22. The distributed fuel cell network of claim 20, wherein the at least one communication linkage includes a wireless communication network.

23. The distributed fuel cell network of claim 20, wherein the at least one communication linkage includes a public communication network.

24. The distributed fuel cell network of claim 20, wherein the at least one communication linkage includes a dedicated communication network.

25. The distributed fuel cell network of claim 1, wherein the fuel includes hydrogen gas and the oxidant includes oxygen.

26. The distributed fuel cell network of claim 25, wherein each fuel cell system includes a source of hydrogen gas.

27. The distributed fuel cell network of claim 26, wherein the measurement subsystem is further adapted to measure one or more operating parameters of the source of hydrogen gas.

28. The distributed fuel cell network of claim 26, wherein the source of hydrogen gas includes at least one hydrogen storage device.

29. The distributed fuel cell network of claim 28, wherein the at least one hydrogen storage device includes at least one of a pressurized tank containing hydrogen gas and a hydride bed containing hydrogen gas.

30. The distributed fuel cell network of claim 26, wherein the source of hydrogen gas includes a fuel processor adapted to produce a product hydrogen stream comprising at least substantially pure hydrogen gas from a feed stream.

31. The distributed fuel cell network of claim 30, wherein the measurement subsystem is adapted to measure one or more operating parameters of the fuel processor.

32. The distributed fuel cell network of claim 31, wherein the measurement subsystem is further adapted to measure one or more operating parameters of the fuel cell stack.

33. The distributed fuel cell network of claim 30, wherein the at least one fuel cell system includes a housing within which the fuel cell stack and the fuel processor are housed.

34. The distributed fuel cell network of claim 30, wherein the feed stream comprises water and a carbon-containing feedstock.

35. The distributed fuel cell network of claim 34, wherein the fuel processor is adapted to produce a mixed gas stream containing hydrogen gas and other gases by steam reforming the feed stream, and further wherein the product hydrogen stream is formed from the mixed gas stream.

36. The distributed fuel cell network of claim 35, wherein the fuel processor includes a separation assembly adapted to receive the mixed gas stream and to produce a byproduct stream and a product stream therefrom, wherein the byproduct stream contains at least a substantial portion of the other gases, the product stream contains at least substantially pure hydrogen gas, and the product hydrogen stream is formed from the product stream.

37. The distributed fuel cell network of claim 36, wherein the separation assembly includes at least one hydrogen-selective membrane.

38. A fuel cell system configured for remote communication, the fuel cell system comprising:
a fuel source;
an oxidant source;
a fuel cell stack configured to produce an electric current from fuel received from the fuel source and oxidant received from the oxidant source;
a measurement subsystem operatively coupled to the fuel cell stack and configured to determine one or more operating parameters of the fuel cell system, wherein the one or more operating parameters at least partially define an operating state of the fuel cell system, and
a fuel cell system communication subsystem in communication with the measurement subsystem and configured to transmit the one or more operating parameters to a remote servicing system.

39. The fuel cell system of claim 38, wherein the fuel source includes a source of hydrogen gas.

40. The fuel cell system of claim 39, wherein the measurement subsystem is further adapted to measure one or more operating parameters of the source of hydrogen gas.

41. The fuel cell system of claim 39, wherein the source of hydrogen gas includes at least one hydrogen storage device.

42. The fuel cell system of claim 41, wherein the at least one hydrogen storage device includes at least one of a pressurized tank containing hydrogen gas and a hydride bed containing hydrogen gas.

43. The fuel cell system of claim 39, wherein the source of hydrogen gas includes a fuel processor adapted to produce a product hydrogen stream comprising at least substantially pure hydrogen gas from a feed stream.

44. The fuel cell system of claim 43, wherein the measurement subsystem is adapted to measure one or more operating parameters of the fuel processor.

45. The fuel cell system of claim 44, wherein the measurement subsystem is further adapted to measure one or more operating parameters of the fuel cell stack.

46. The fuel cell system of claim 43, wherein each fuel cell system includes a housing within which the fuel cell stack and the fuel processor are housed.

47. The fuel cell system of claim 43, wherein the feed stream comprises water and a carbon-containing feedstock.

48. The fuel cell system of claim 47, wherein the fuel processor is adapted to produce a mixed gas stream containing hydrogen gas and other gases by steam reforming the feed stream, and further wherein the product hydrogen stream is formed from the mixed gas stream.

49. The fuel cell system of claim 48, wherein the fuel processor includes a separation assembly adapted to receive the mixed gas stream and to produce a byproduct stream and a product stream therefrom, wherein the byproduct stream contains at least a substantial portion of the other gases, the product stream contains at least substantially pure hydrogen gas, and the product hydrogen stream is formed from the product stream.

50. The fuel cell system of claim 49, wherein the separation assembly includes at least one hydrogen-selective membrane.

51. The fuel cell system of claim 38, wherein the fuel cell system further comprises a local controller adapted to control the operation of the fuel cell system.

52. The fuel cell system of claim 51, wherein the local controller is adapted to receive control signals from the remote servicing system and to control the operation of the fuel cell system at least partially responsive thereto.

53. The fuel cell system of claim 51, wherein the local controller is in communication with the measurement subsystem and is adapted to control the operation of the fuel cell system at least partially responsive to the one or more operating parameters determined by the measurement subsystem.

54. The fuel cell system of claim 38, wherein the fuel cell system does not include a local controller adapted to control the operation of the fuel cell system.

55. The fuel cell system of claim 38, wherein each of the at least one fuel cell system is located at least 50 feet away from the remote servicing system.

56. The fuel cell system of claim 55, wherein each of the at least one fuel cell system is located at least one mile away from the remote servicing system.

57. A method of servicing a remotely located fuel cell system, the method comprising:
receiving transmitted operating parameters from a fuel cell system, wherein the operating parameters model an operating state of the fuel cell system; and
remotely monitoring the operating state of the fuel cell system via the transmitted operating parameters.

58. The method of claim 57, further comprising transmitting operating instructions to the remotely located fuel cell system, wherein the operating instructions are configured to alter the operating state of the fuel cell system.

59. The method of claim 57, wherein the operating instructions are configured to activate operation of the fuel cell system.

60. The method of claim 59, wherein the operating instructions are configured to deactivate operation of the fuel cell system.

61. The method of claim 57, further comprising transmitting a notification configured to provide information regarding the operating state of the fuel cell system.

62. A method of preventing fuel cell system failure, the method comprising:
receiving transmitted operating parameters from a remotely located fuel cell system, wherein the operating parameters model at least a portion of an operating state of the fuel cell system, wherein the fuel cell system includes at least one fuel cell stack adapted to produce an electric current from a fuel and an oxidant;
remotely monitoring the operating state of the fuel cell system via the transmitted operating parameters;
analyzing the operating state to detect at least one of an impending failure and a future operating state of the fuel cell system; and
transmitting to the remotely located fuel cell system operating instructions configured to adjust the operating state of the fuel cell system at least partially responsive to the analysis.

63. The method of claim 62, wherein the analyzing step includes analyzing the operating state over time to detect a trend indicative of at least one of an impending failure and a future operating state of the fuel cell system.

64. The method of claim 63, wherein the analyzing step includes analyzing the operating state over time to detect a trend indicative of an impending failure of the fuel cell system.

65. The method of claim 64, wherein the transmitting step includes sending operating instructions configured to adjust the operating state of the fuel cell system to prevent the impending failure.

66. The method of claim 65, wherein the transmitting step includes sending operating instructions configured to shutdown the fuel cell system.

67. The method of claim 63, wherein the analyzing step includes analyzing the operating state over time to detect a trend that indicates a future operating state of the fuel cell system.

68. The method of claim 67, wherein the transmitting step includes transmitting operating instructions configured to adjust the operating state of the fuel cell system to prevent the fuel cell system from operating at the future operating state.

69. The method of claim 68, wherein the transmitting step includes transmitting operating instructions responsive at least in part to the detected trend.
